(19) United States
(12) Patent Application Publication
(10) Pub. No.: US 2014/0157110 A1
(43) Pub. Date: Jun. 5, 2014

(54) BROWSER TOOLBAR EXTENSION FOR DOCUMENT MANAGEMENT WITH WEB-BASED APPLICATION PROGRAMS

(71) Applicant: SmartVault Corporation, Houston, TX (US)

(72) Inventors: John David Abbott, JR., Houston, TX (US); Michael R. Webb, Houston, TX (US)

(73) Assignee: SMARTVAULT CORPORATION, Houston, TX (US)

(21) Appl. No.: 14/093,433

(22) Filed: Nov. 30, 2013

Related U.S. Application Data
(60) Provisional application No. 61/731,494, filed on Nov. 30, 2012.

(51) Int. Cl. G06F 17/22

(52) U.S. Cl. CPC G06F 17/2247
USPC 715/234

(57) ABSTRACT

A browser extension relates to a Web application such as QuickBooks Online that manages data records, for example, data records about sales transactions. The extension allows a user to store, at a different Web server or other repository, supplemental records relating to particular data records of the Web application; for example, the user, when displaying a sales-transaction data record in the Web application's display window, could attach and/or view a scanned copy of the physical invoice document for the transaction, even if the Web application does not provide that capability natively. When the user is displaying data from the Web application's data record concerning that sales transaction, the browser extension displays, in an auxiliary display area, information about the supplemental records for that transaction's data record, such as (for example) the number of scanned documents “attached” to that data record, and allows the user to view copies of documents on the screen.

This application claims priority based on our co-pending provisional patent application No. 61/731,494, filed Nov. 30, 2012, which is incorporated herein by reference.

This application also incorporates by reference the commonly-owned U.S. Pat. No. 8,286,199, “Automated method for creating a graphical user interface for a document management system that is visually integrated with an application having limited native GUI-integration capabilities,” by Pulaski et al., issued Oct. 9, 2012, referred to here as “the '199 patent.”

### 1. BACKGROUND OF THE INVENTION

THE SMARTVAULT TOOLBAR: Our invention builds on the technology disclosed and claimed in the '199 patent. (The citation of the '199 patent here should not be construed as a concession that the '199 patent per se constitutes prior art to the invention described and claimed here.) Our invention traces its origins to a related software package for online electronic document management developed by the applicant, SmartVault Corporation. That software package, known as the SmartVault® application, provides an add-on toolbar for the well-known QuickBooks® small-business accounting software published by Intuit Inc.

BROWSER-BASED WEB APPLICATIONS: The '199 patent notes that “[i]n Web-based implementations, the operating platform 110 may be a Web browser such as Firefox®, Internet Explorer®, Chrome™, Opera™, Flock™, Safari,® etc.” (At col. 3, lines 4-9.) Such Web-based platforms have become increasingly common, with browser-based applications (often referred to as Web applications or simply Web apps), such as QuickBooks Online®, playing a significant role in both business and consumer applications.

(As is well-known to those of ordinary skill, a Web application generally takes the form of an HTML “client” front end, commonly downloaded from a Web service, that is executed by a user's computer to communicate with the Web service using a protocol such as HTTP or HTTPS.)

BROWSER EXTENSIONS: Current implementations of major Web browsers provide mechanisms whereby developers may add functionality by creating browser extensions that can be installed by browser users. For general information in this regard, see the Wikipedia article “Browser extension,” for example in the version dated 13:49 Oct. 27, 2011, which asserts that “A browser extension is a computer program that extends the functionality of a web browser in some way. Depending on the browser and the version, the term may be distinct from similar terms such as plug-in or add-on. Mozilla Firefox was designed with the idea of being a small and simple web browser, delegating more advanced functions to Mozilla extensions. Microsoft Internet Explorer started supporting extensions from version 5. Google Chrome started supporting extensions from version 4. The Opera desktop web browser supported extensions from version 10. The Apple Safari web browser started supporting native extensions from version 5.” (Bracketed notes omitted; that version of the article is available at the (shortened) Web link goo.gl/faWz8F.)

EXTENDING THE SMARTVAULT TOOLBAR TO THE BROWSER: We realized that our colleagues' basic approach to creating an add-on toolbar for desktop applications such as QuickBooks, as documented in the '199 patent, could be implemented for browser-based Web applications, as suggested in that patent, by using such browser-extension capabilities. We wanted to give users of the QuickBooks Online, Freshbooks, and Xero accounting packages, as well as other browser-based Web applications, the ability shown in the '199 patent (1) to “attach” supplemental records and/or related information, such as (for example) electronic copies of invoices, to specific data records (for example, specific QuickBooks Online data records), and then (2) to be able to easily access the supplemental records and/or related information, for example by displaying lists of such supplemental records (and/or the contents of one or more of them) on the screen, while still viewing the associated data records in the Web application in the usual way.

### 2. SUMMARY OF THE INVENTION

In one embodiment of our invention, a browser extension, running as an extension of a browser program on a computer, allows a user to store, in a repository, supplemental records containing information such as (for example) document images, and to associate particular supplemental records with specified states of a browser-based Web application such as, for example, QuickBooks Online. This process of storage and association can be thought of as “attaching” supplemental records to particular data records maintained by the Web application, even (indeed, especially) when the Web application itself does not offer any native attachment capability. The browser extension then responds to notifications of specific events occurring in the browser, via the browser's API, as the user utilizes the Web application's various capabilities. When the browser extension determines that a particular data record is being displayed by the Web application in the browser (or is about to be displayed), or that some other particular state exists (or is about to exist) in the Web application, the browser extension automatically obtains information about the specified data record or the specified state, such as a list or count of one or more supplemental records (for example, electronic documents) that are associated with the specified data record or the specified state. The browser extension then automatically displays, in an auxiliary display area of the browser window (created using one or more HTML elements), summary information about the supplemental records (for example, a count of the number of documents that are associated with a bill being viewed on the screen), and/or the contents of one or more of the supplemental records themselves, and/or other status information. In our particular embodiment, the auxiliary display area is a toolbar or sidebar window located within the display of the Web application itself. The foregoing is achieved utilizing standard document object model (DOM) modification functionality.

### 3. BRIEF DESCRIPTION OF THE DRAWINGS

FIG. 1 is a block diagram of a computer system and two Web services used in an illustrative implementation of the invention.

FIG. 2 is a gray-scale copy of a “screen shot” of an auxiliary window displayed in a browser window in accordance with the invention.

### 4. DETAILED DESCRIPTION OF SPECIFIC EMBODIMENTS

We describe below how to make and use some specific embodiments of the invention we are claiming. In the interest of brevity and clarity, we focus on what might colloquially be called the “secret sauce,” omitting various routine software design- and implementation details that would be apparent to (or readily discoverable by) suitably diligent persons of ordinary skill. We do not discuss, for example, the selection of appropriate programming languages except by illustrative example; the development of user interfaces except to a limited extent; considerations of data security; and the like.

As an illustrative example, we describe how the invention helps one particular implementation of the browser extension, namely the SmartVault browser toolbar extension, to interoperate with a particular Web application, namely the QuickBooks Online application. In hindsight, of course, those of ordinary skill will quickly see that the invention can be implemented in other browser extensions to support other Web applications.

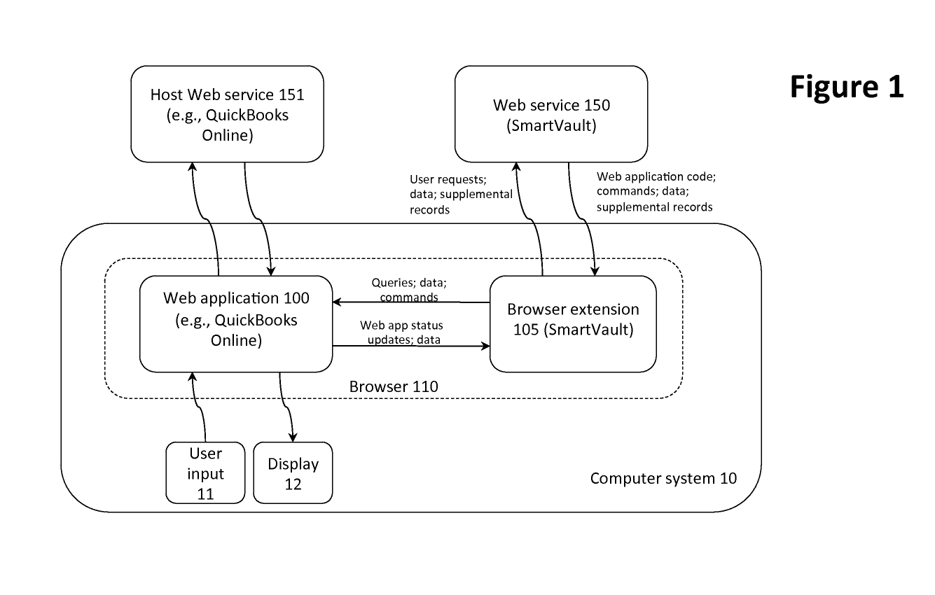

COMPUTER SYSTEM: Referring to FIG. 1, a conventional computer system 10 includes a conventional user input 11 and a conventional display 12. The computer system 10 may take the form of a desktop or laptop computer; a tablet such as an iPad; or a smartphone such as an iPhone. The computer system 10 may be controlled by an operating system such as Microsoft Windows®; descendants of Unix® such as Mac OS® X or various implementations GNU/Linux®; iOS®; Android™, etc. The user input 11 may be a conventional input such as a keyboard; a mouse; a touch screen; voice-recognition software; and the like. The display 12 may be a comparatively-large desktop monitor, or it may be integrated with the user input 11, for example in the case of a tablet or a smartphone.

WEB BROWSER: The computer system 10 runs a Web browser program 110, corresponding to the operating platform 110 of the '199 patent. The browser 110 may be any convenient browser that permits the installation of extensions having the functionality described below, such as Microsoft's Internet Explorer® browser; Mozilla's Firefox® browser; Google's Chrome™ browser, Opera Software's Opera™ browser; Apple's Safari® browser; etc. (The SmartVault browser extension program described here does not yet support all these browsers but such support is planned for the future.)

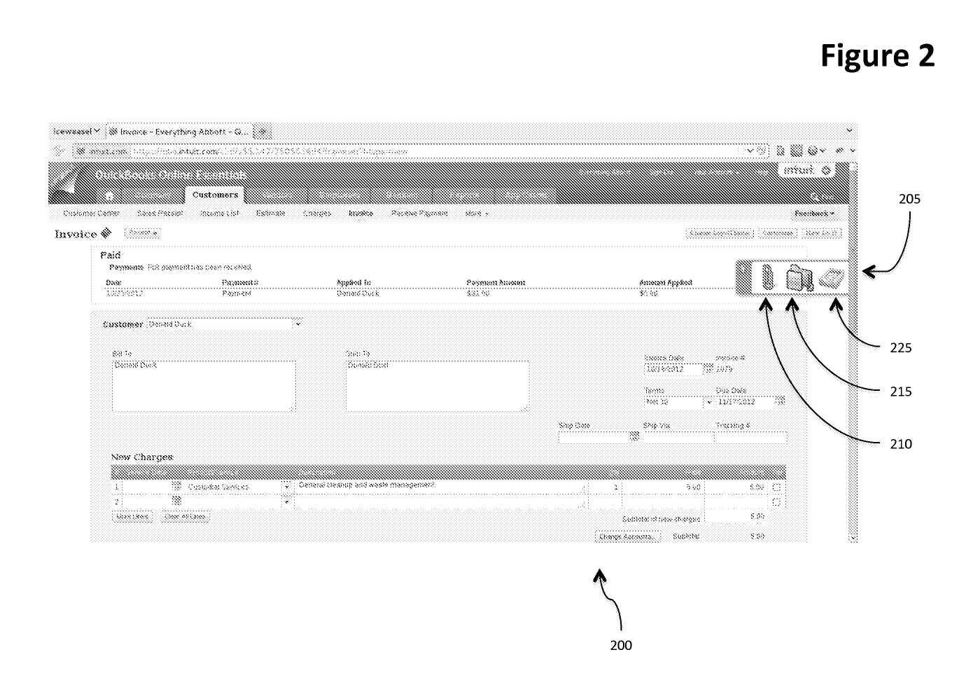

WEB APPLICATION: The browser 110 executes a Web application program 100, corresponding to the main application 100 of the '199 patent. Referring to FIG. 2, the Web application 100 causes the browser 110 to display, on the display 12, a window 200 containing various items of information relating to a specific data record, which in this illustrative example is an hypothetical invoice relating to “Donald Duck,” a well-known fictional name used as a convenient placeholder. (For the avoidance of doubt, neither this invention nor SmartVault Corporation are related to, sponsored by, or endorsed by the Walt Disney Company.)

The Web application program 100 normally will be downloaded via the Internet (or other network) from a repository such as a Web service 151. (As used here, the term “Web service” is intended to encompass not only single Web servers but also more-sophisticated arrangements of multiple server-type computer systems arranged in distributed systems. Those of ordinary skill will appreciate that the Web application 100 could also be loaded from a local data store at the computer system 10, such as a fixed-disk drive a.k.a. a hard disk; a fixed solid-state drive a.k.a. an SSD; or a removable solid-state drive such as a so-called thumb drive.)

Importantly, the Web application 100 has an application programming interface, or “API,” that allows other programs (such as the browser extension, discussed below) to interact with the Web application.

BROWSER EXTENSION: A browser extension 105, providing functionality comparable to that of the add-on program 105 of the '199 patent, is conventionally installed into the browser 110, for example by using the user input 11 to click on or otherwise select a link or icon shown on the display 12. A “snapshot” listing of source code for our QuickBooks Online implementation at a particular point in time is included as Appendixes A through D of this specification.

OPERATIONAL OVERVIEW: The browser extension 105 operates in essentially the same manner as the add-on program 105 of the '199 patent (with suitable adjustments to take into account the change from a desktop platform to a Web-based platform). In a nutshell, referring to FIG. 2, the browser extension 105 uses the API of the browser 100 to show an auxiliary display area 205 (corresponding to the auxiliary window 205 of the '199 patent) in the browser window.

In the example shown in FIG. 2, a conventional paperclip icon 210 offers a convenient and familiar way for a user to associate a supplemental record such as a document, file, etc., with either (i) a specified data record or (ii) a particular state of the Web application 100. For example, by clicking on the paperclip icon 210, the user can cause the browser extension 105 to store an electronic copy of a document, etc., along with related information obtained from the Web application 100, in a suitable repository such as the (SmartVault) Web server 150 and to associate that electronic copy with the data record then being displayed by the (QuickBooks Online) Web application (for example, the Donald Duck invoice record shown in FIG. 2) or with the then-current state of the Web application.

Still referring to FIG. 2, a document icon 215 shows the summary information that two documents are thus ‘attached’ to the Donald Duck invoice record shown in the drawing. By clicking on this icon, the user can display a list of the attached documents (the list being retrieved from the repository 150 by the browser extension 105) and select one or more of them for display or other processing.

An icon 225 offers a way for a user to associate a supplemental record such as a document, file, etc., that is found in the SmartVault repository 150 with a specified data record or a particular state of the Web application 100.

Importantly, as in the '199 patent, the browser extension 105 updates the auxiliary display area 205 automatically in response to certain state changes in the Web application 100, by (1) obtaining additional information about the data record (sometimes referred to as meta-data) from the (QuickBooks Online) Web application 100, via that Web application's own API, to get more detail regarding a potential state change, such as a record identifier for a data record currently being viewed by the user; and (2) updating the information displayed in the auxiliary display area 205, possibly including retrieving related information from the (SmartVault) Web server 150.

Additional details about the general operation of the browser extension 105 can be found in the detailed description in the '199 patent, again with appropriate adjustments to take into account the change from a desktop-based to a Web-based program. Those of ordinary skill having the benefit of this disclosure will be able to discern still more details from the additional information in part 5 below and from the program source code listings in Appendixes A through D below.

PROGRAMMING; PROGRAM STORAGE DEVICE: The system and method described may be implemented by programming suitable general-purpose computers to function as the various server- and client machines shown in the drawing figures and described above. The programming may be accomplished through the use of one or more program storage devices readable by the relevant computer, either locally or remotely, where each program storage device encodes all or a portion of a program of instructions executable by the computer for performing the operations described above. The specific programming is conventional and can be readily implemented by those of ordinary skill having the benefit of this disclosure. A program storage device may take the form of, e.g., a hard disk drive, a flash drive, another network server (possibly accessible via Internet download), or other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

ALTERNATIVES: The above description of specific embodiments is not intended to limit the claims below. Those of ordinary skill having the benefit of this disclosure will recognize that modifications and variations are possible; for example, some of the specific actions described above might be capable of being performed in a different order.

### 5. ADDITIONAL COMMENTS

Excerpts from the above-referenced provisional patent application are reproduced below.

### I. Synopsis

Our invention is the pattern by which one company (A) may seamlessly extend, by use of a web browser extension, the functionality of another company's (B, which may also be A) web application to include context relevant services provided by a third company (C, which may also be A or B).

### II. Design

### A. Web Browser Extension

Current implementations of major web browsers provide mechanisms whereby developers may extend those web browsers to perform functionality in addition to the base functionality offered by those web browsers though the creation of web browser extensions. This functionality is often expressed using the event metaphor, wherein the extensions may express desire to be informed of specific events when they occur within the web browser. These events include such things as opening the web browser, navigation to a specific web resource, and closing the web browser.

We use web browser extensions to facilitate interaction with web applications, including those written by third parties. This technology provides the means by which we may detect that given third party web applications are active and to interact directly with the specific components of those web applications. This interaction includes, but is not limited to: detecting the current uniform resource identifier (URI) of each resource loaded by the web application, interacting with the document object model (DOM) of the web application, interacting with the web browser cookies stored by the web application, and interacting directly with the client-side web browser code used by the web application.

### B. Seamless Application Extension Based on Detected Context

We detect contexts for which we are interested in performing specific interactions with a third party service and are thus able to extend the target web application seamlessly [Appendix-A: Javascript code for generalized context detection, Appendix-B: Javascript code for QuickBooks Online context detection].

Once we have determined the context for which additional functionality should be presented, we may then present that functionality by extending the DOM of the target web application with our own DOM nodes.

The added functionality does not distract the user from normal usage of the web application but instead integrates smoothly with the native functionality of the web application

### C. Interaction with Third Party Services

Various mechanisms may be used to interact with third party services. These interactions may be as straightforward as utilizing the built in XMLHttpRequest object provided by modern web browsers to communicate with published application programming interfaces (APIs) [Appendix-C: Javascript library for interacting with the SmartVault REST API], or may be as roundabout as using form submission, sending the response to another web browser frame, then inspecting the response programmatically, or even embedding the response directly.

The key to this interaction is that it is specific to the context of the web application.

### III. Reference Implementation

We use the Kango cross-browser extension framework (http://kangoextensions.com) to facilitate the development of web browser extensions [Appendix-D: Background web browser extension code].

Our extensions implement our design in two different fashions. In the first fashion, our extensions watch for the navigation to specific web resources (QuickBooks Online (QBO)) that we have inspected prior and added functionality specifically to deal with those resources when detected. In the second fashion, our extensions inspect every web resource loaded and search for embedded directives that our extensions may then use to perform relevant operations via the SmartVault REST API.

The functionality we added detects via context the various entities represented by the QBO web application, items such as invoices, bills, receipts, etc. Each specific context is then used to uniquely identify where documents may be attached. These documents are stored, retrieved, and manipulated using the SmartVault service.

### IV. Resource-Flow

1. User opens web browser.

2. User installs browser extension. This step may occur before or after the web browser has been opened, depending on the web browser being used or may require the web browser to restart.

3. User identifies herself to browser extension. This is an optional step that may be necessary based on the requirements of the third-party service. When using the SmartVault REST API as a the third-party service, the user must identify herself for the purposes of determining where the attached documents are to be stored.

4. User activates web application. In the reference implementation, this means navigating to QuickBooks Online.

5. User performs an action within the web application that results in reaching a relevant context. In the reference implementation, this means reaching a transaction where the user will be allowed to make document attachments. Examples are such things as invoices, bills, purchase orders, checks, etc.

6. Browser extension detects context and provides user with additional functionality. Appropriate controls are provided for the user to allow appropriate interaction with the third party service. For the reference implementation, this means providing the controls to allow the user to manipulate the documents that are attached to a given QuickBooks Online transaction.

7. User interacts with browser extension-provided additional functionality. The reference implementation allows attaching documents via file upload, attaching documents from elsewhere in their SmartVault storage, deleting attached documents, and editing metadata for attached documents.

8. Browser extension interacts with third-party service on behalf of the user.

9. Browser extension adjusts user interface based on new state.

We claim:

1. A method, executed by a computer system (10) that operates under control of a browser extension program (105), referred to as an extension, where:
(i) the extension operates in conjunction with a Web browser program (110), referred to as a browser;
(ii) the browser executes instructions of an application program (100), referred to as a Web application;
(iii) the Web application allows a user to manage data records stored by a Web service (151); and
the method comprises the following:
(a) the extension determines, through interaction with the browser via its API, that the Web application is displaying a particular data record on a display (12) of the computer system;
(b) the extension obtains an identifier of the particular data record being displayed;
(c) the extension, via the browser API, receives a command from the user to attach at least one of said supplemental records to the particular data record, using one or more function calls of an application programming interface (API) of the browser;
(e) the extension causes a Web-based repository (150) to store respective copies of each of the one or more supplemental records; and
(f) the extension causes the Web-based repository to record an association between the one or more supplemental records and the particular data record being displayed by the Web application.

2. A method, executed by a computer system (10) that operates under control of a browser extension program (105), referred to as an extension, where:
(i) the extension operates in conjunction with a Web browser program (110), referred to as a browser;
(ii) the browser executes instructions of an application program (100), referred to as a Web application;
(iii) the Web application allows a user to manage data records stored by a Web service (151); and
the method comprises the following:
(a) the extension determines, through interaction with the browser via its API, that the Web application is displaying a particular data record on a display (12) of the computer system;
(b) the extension obtains, from a Web-based repository (150), an identifier of the particular data record being displayed;
(c) the extension obtains information, stored in the Web-based repository, about one or more supplemental records that are associated with the identifier;
(d) the extension, via the browser API, causes the browser to display, in an auxiliary display area (205) on the display, information about at least one of said supplemental records, using one or more function calls of an application programming interface (API) of the browser.

3. The method of claim 2, further comprising the following:
(e) the extension (105), via the API of the browser (110), receives a command from a user;
(f) the command specifies a supplemental record to be retrieved from the Web-based repository (150);
(g) the extension, via the browser API, causes the browser to retrieve, from the repository, at least a portion of the content of the supplemental record, and to display that portion on the display (12).

4. A program storage device containing a machine-readable description of instructions for performing the operations described in claim 1.

5. A program storage device containing a machine-readable description of instructions for performing the operations described in claim 2.

6. A program storage device containing a machine-readable description of instructions for performing the operations described in claim 3.
